(19) United States
(12) Patent Application Publication
(10) Pub. No.: US 2026/0350998 A1
(43) Pub. Date: Nov. 5, 2026

(54) COMMUNICATION DEVICE, IMAGING DEVICE, AND COMMUNICATION METHOD

(71) Applicant: SONY SEMICONDUCTOR SOLUTIONS CORPORATION, KANAGAWA (JP)

(72) Inventors: TAKAFUMI SUZUKI, KANAGAWA (JP); DAIKI MISONO, KANAGAWA (JP)

(21) Appl. No.: 19/485,680

(22) PCT Filed: Apr. 8, 2024
(86) PCT No.: PCT/JP2024/014289

§ 371 Date: Nov. 19, 2025

(30) Foreign Application Priority Data
May 31, 2023 (JP) 2023-089729

(51) Int. Cl. G06V 20/52; G06V 10/82; H04N 7/18; H04N 23/65

(52) U.S. Cl. CPC G06V 20/52; H04N 7/183; H04N 23/651; G06V 10/82

(57) ABSTRACT

The present disclosure makes it possible to suppress wasted power consumption during communication. A communication device includes a determination unit configured to determine a feature of data and a communication unit configured to communicate, on the basis of a determination result of the feature of the data, the determination result. The communication device may further include a feature detection unit configured to detect the feature of the data. The communication unit may transmit the determination result when an abnormality is determined to exist in the feature of the data and suspend the communication when an abnormality is determined to not exist in the feature of the data. The communication device may further include a sensor configured to generate the data. The communication device may further include a controller configured to control the sensor. The controller may include the determination unit and the communication unit.

### TECHNICAL FIELD

The present technology relates to a communication device, an imaging device, and a communication method. Specifically, the present technology relates to a communication device, an imaging device, and a communication method that can execute communication on the basis of a determination result of data.

### BACKGROUND ART

In the monitoring of an abnormality or the like, communication may be performed in accordance with a determination result of a monitoring result. For example, a communication device has been proposed that, upon detection of a fall of a person wearing the communication device, determines a degree of overlap between a transmission path of a radio signal and a body of the person, and transmits the radio signal in a transmission mode according to the determination result (refer to PTL 1, for example).

### CITATION LIST

### Patent Literature

PTL1: JP 2020-27536 A

### SUMMARY

### Technical Problem

However, in the technology in the related art described above, communication is implemented with an output level lowered even in a case of a favorable communication environment. Therefore, in the monitoring of an abnormality or the like, there is a possibility of wasted power consumption in a case in which an abnormality does not exist.

The present technology has been made in view of such circumstances, and an object thereof is to make it possible to suppress wasted power consumption during communication.

### Solution to Problem

The present technology has been made to solve the problems described above, and a first aspect thereof is a communication device including a determination unit configured to determine a feature of data and a communication unit configured to communicate, on the basis of a determination result of the feature of the data, the determination result. According to this configuration, an effect of reducing a communication amount on the basis of the determination result of the feature of the data is achieved.

Further, in the first aspect, the communication device may further include a feature detection unit configured to detect the feature of the data. According to this configuration, an effect of enabling determination of the feature of the data is achieved.

Further, in the first aspect, the communication device may further include a sensor configured to generate the data. According to this configuration, an effect of acquiring data with the feature determined is achieved.

Further, in the first aspect, the sensor may include the feature detection unit. According to this configuration, an effect of detecting the feature of the data by the sensor is achieved.

Further, in the first aspect, the sensor may include the determination unit. According to this configuration, an effect of determining the feature of the data by the sensor is achieved.

Further, in the first aspect, the communication device may further include a controller configured to control the sensor. According to this configuration, an effect of linking the generation of data by the sensor and the detection of the feature of the data by the sensor is achieved.

Further, in the first aspect, the controller may include the determination unit and the communication unit. According to this configuration, an effect of linking the detection of the feature of the data by the sensor and the determination of the feature of the data by the controller is achieved.

Further, in the first aspect, the communication unit may transmit the determination result when an abnormality is determined to exist in the feature of the data and suspend the communication when an abnormality is determined to not exist in the feature of the data. According to this configuration, an effect of reducing the communication amount when an abnormality is determined to not exist in the feature of the data is achieved.

Further, in the first aspect, the communication device may further include a remaining amount detection unit configured to detect a remaining amount of a battery configured to drive the determination unit and the communication unit. According to this configuration, an effect of driving the determination unit and the communication unit by the battery on the basis of the remaining amount of the battery is achieved.

Further, in the first aspect, the communication unit may transmit the data and the determination result when the remaining amount of the battery is a first remaining amount or greater and transmit the determination result without transmitting the data when the remaining amount of the battery is less than the first remaining amount. According to this configuration, an effect of reducing the communication amount when the remaining amount of the battery is low is achieved.

Further, in the first aspect, the communication unit may transmit the data and the determination result when the remaining amount of the battery is equal to or less than a second remaining amount that is less than the first remaining amount and collectively transmit a plurality of the determination results when the remaining amount is less than the first remaining amount. According to this configuration, an effect of reducing a communication count when the remaining amount of the battery is low is achieved.

Further, in the first aspect, the communication unit may extend a communication interval on the basis of the remaining amount of the battery. According to this configuration, an effect of reducing the communication amount on the basis of the remaining amount of the battery is achieved.

Further, in the first aspect, the communication device may further include a power supply control unit configured to switch to battery power by a spare battery on the basis of the remaining amount of the battery. According to this configuration, an effect of driving the communication device by the spare battery when the remaining amount of the battery is low is achieved.

Further, in the first aspect, the communication unit may extend a communication interval on the basis of a change amount in the data. According to this configuration, an effect of reducing the communication amount when the change amount in the data is small is achieved.

Further, in the first aspect, the communication unit may transmit the determination result when the feature of the data changes and suspend the communication when the feature of the data does not change. According to this configuration, an effect of reducing the communication amount when a change does not exist in the feature of the data is achieved.

Further, in the first aspect, the communication unit may transmit an operation state on the basis of activation. According to this configuration, an effect of allowing recognition of the operation state of the communication unit while enabling suspension of the communication unit is achieved.

Further, a second aspect is an imaging device including an imaging unit configured to perform imaging, a detection unit configured to detect a feature of image data generated by the imaging unit, a determination unit configured to determine the feature of the image data, and a communication unit configured to communicate, on the basis of a determination result of the feature of the image data, the determination result. According to this configuration, an effect of reducing the communication amount on the basis of the determination result of the feature of the image data is achieved.

Further, in the second aspect, the communication unit may transmit the determination result when an abnormality is determined to exist in the feature of the image data and suspend transmission of the determination result when an abnormality is determined to not exist in the feature of the image data. According to this configuration, an effect of reducing the communication amount when an abnormality is determined to not exist in the feature of the image data is achieved.

Further, a third aspect is a communication method including determining a feature of data by a server, and receiving, on the basis of communication implemented according to a determination result of the feature of the data, the determination result by the server. According to this configuration, an effect of reducing a communication amount on the basis of the determination result of the feature of the data is achieved.

Further, in the third aspect, the server may receive the determination result when an abnormality is determined to exist in the feature of the data, and the server may suspend reception of the determination result when an abnormality is determined to not exist in the feature of the data. According to this configuration, an effect of reducing the communication amount when an abnormality is determined to not exist in the feature of the data is achieved.

### BRIEF DESCRIPTION OF DRAWINGS

FIG. 1 is a block diagram depicting a configuration example of an imaging device according to a first embodiment.

FIG. 2 is a diagram depicting an example of a communication sequence according to the first embodiment.

FIG. 3 is a diagram depicting another example of the communication sequence according to the first embodiment.

FIG. 4 is a flowchart depicting an example of a communication method according to the first embodiment.

FIG. 5 is a block diagram depicting a configuration example of an imaging device according to a second embodiment.

FIG. 6 is a diagram depicting an example of the communication sequence according to the second embodiment.

FIG. 7 is a flowchart depicting an example of the communication method according to the second embodiment.

FIG. 8 is a block diagram depicting a configuration example of an imaging device according to a third embodiment.

FIG. 9 is a diagram depicting an example of the communication sequence according to the third embodiment.

FIG. 10 is a flowchart depicting an example of the communication method according to the third embodiment.

FIG. 11 is a flowchart depicting an example of the communication method according to a fourth embodiment.

FIG. 12 is a block diagram depicting a configuration example of an imaging device according to a fifth embodiment.

FIG. 13 is a flowchart depicting an example of the communication method according to the fifth embodiment.

FIG. 14 is a diagram depicting an example of the communication sequence according to a sixth embodiment.

FIG. 15 is a flowchart depicting an example of the communication method according to the sixth embodiment.

FIG. 16 is a diagram depicting an example of the communication sequence according to a seventh embodiment.

FIG. 17 is a flowchart depicting an example of the communication method according to the seventh embodiment.

FIG. 18 is a block diagram depicting a configuration example of an imaging device according to an eighth embodiment.

FIG. 19 is a flowchart depicting an example of the communication method according to the eighth embodiment.

FIG. 20 is a perspective view depicting a layering example of a solid-state imaging device according to a ninth embodiment.

FIG. 21 is a block diagram depicting a schematic configuration example of a vehicle control system.

FIG. 22 is an explanatory view depicting an example of an installation position of an imaging section.

### DESCRIPTION OF EMBODIMENTS

Hereinafter, modes for carrying out the present technology (hereinafter, referred to as embodiments) will be described.

Description will be made in the following order.
1. First Embodiment (example in which a determination result is transmitted in a case in which an abnormality is determined to exist in a feature of image data, and communication is suspended in a case in which an abnormality is determined to not exist in the feature of the image data)
2. Second Embodiment (example in which, in a case in which an abnormality is determined to exist in the feature of the image data, an image and the determination result are transmitted when a remaining battery amount is sufficient, and only the determination result is transmitted when the remaining battery amount is low)
3. Third Embodiment (example in which, in a case in which an abnormality is determined to exist in the feature of the image data, a plurality of the determination results are collectively transmitted when the remaining battery amount is substantially depleted)
4. Fourth Embodiment (example in which a communication interval is extended when the remaining battery amount is low)
5. Fifth Embodiment (example in which a switch is made to a spare battery when the remaining battery amount is low) 6. Sixth Embodiment (example in which the communication interval is shortened when a change in the image data is large, and the communication interval is extended when a change in the image data is small)
7. Seventh Embodiment (example in which, in a case in which an abnormality is determined to exist in the feature of the image data, the determination result is transmitted when a change exists from the previous communication time, and the determination result is not transmitted when a change does not exist from the previous communication time)
8. Eighth Embodiment (example in which a determination unit that determines the feature of the image data is provided in an image sensor)
9. Ninth Embodiment (example in which semiconductor chips forming a solid-state imaging device are layered)
10. Application Example to Mobile Body

### 1. First Embodiment

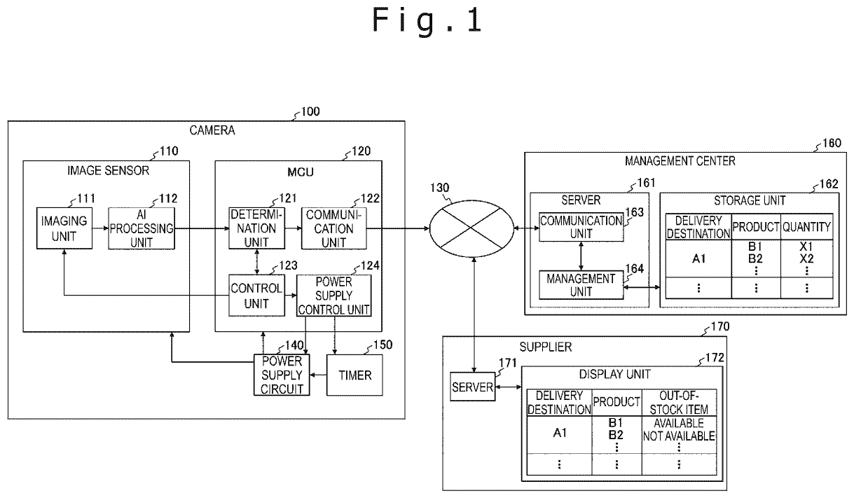

FIG. 1 is a block diagram depicting a configuration example of an imaging device according to a first embodiment.

In FIG. 1, a camera 100 generates image data on the basis of imaging and transmits the image data. The camera 100 may operate on the basis of battery power. At this time, the camera 100 may be used in environments where power cannot be easily secured, such as in river monitoring or farm monitoring, or may be used in environments where power construction is difficult, such as in shelf monitoring in convenience stores or supermarkets. The camera 100 may be mounted on a mobile body such as a drone, or may be mounted on a mobile terminal such as a smartphone. Note that the camera 100 is an example of an imaging device described in the claims.

The camera 100 includes an image sensor 110 and a micro controller unit (MCU) 120. The image sensor 110 is connected to the MCU 120. An interface used for connection between the image sensor 110 and the MCU 120 may be, for example, a serial peripheral interface (SPI) or may be a mobile industry processor interface (MIPI). The MCU 120 is connected to a network 130. The image sensor 110 and the MCU 120 are supplied with power via a power supply circuit 140. The power supply circuit 140 is connected to a timer 150.

The image sensor 110 implements imaging to generate image data. The image sensor 110 may be an event-based vision sensor or may be a distance measurement sensor. The image sensor 110 includes an imaging unit 111 and an artificial intelligence (AI) processing unit 112.

The imaging unit 111 generates a pixel signal on the basis of imaging, and digitizes and outputs the pixel signal. Pixels can be disposed in a matrix in a row direction and a column direction. Each pixel may include a photodiode or may include a single photon avalanche diode (SPAD). The imaging unit 111 may output an image or may output an event. Distance measurement data such as depth information may be added to the image. Note that the imaging unit 111 is an example of a sensor described in the claims.

The AI processing unit 112 detects a feature of the image data. The AI processing unit 112 can implement inference processing such as abnormality detection, object detection, behavior detection, and posture detection on the basis of the image data. Note that the abnormalities detected by the AI processing unit 112 may include, for example, an abnormality having low urgency and an abnormality having high urgency, or may include an abnormality having low importance and an abnormality having high importance. For example, the abnormalities detected by the AI processing unit 112 can include abnormalities that may be left unattended, abnormalities that prompt attention, abnormalities that require periodic response, abnormalities that require urgent response, and the like. The AI processing unit 112 may include a processor or may include a neural network. The AI processing unit 112 may execute processing on the basis of a rule base or may execute processing on the basis of machine learning. The AI processing unit 112 is not necessarily provided in the image sensor 110, and may be provided in the MCU 120. Note that the AI processing unit 112 is an example of a feature detection unit described in the claims.

The MCU 120 controls the image sensor 110 and transmits the image data to the network 130 on the basis of a determination result of the feature of the image data. The feature of the image data may be an abnormality of a subject of an imaged image, may be an object or a person appearing in an imaged image, may be a behavior of a person appearing in an imaged image, or may be a posture of an object or a person appearing in an imaged image. For example, in river monitoring, the feature may be a rising level of the river or flooding. In farm monitoring, the feature may be pest emergence or crop withering. In shelf monitoring in a convenience store, the feature may be an out-of-stock state of a displayed product. The MCU 120 may include a processor or may include a neural network. The MCU 120 includes a determination unit 121, a communication unit 122, a control unit 123, and a power supply control unit 124. Note that the MCU 120 is an example of a controller described in the claims.

The determination unit 121 determines a feature of the image data that is detected by the AI processing unit 112. For example, the determination unit 121 can determine whether a feature among the features of the image data detected by the AI processing unit 112 is a feature that requires notification. At this time, the determination unit 121 can determine whether the feature of the image data detected by the AI processing unit 112 is a feature that requires notification on the basis of the urgency or the importance of the feature. Then, in a case in which the feature is determined to require notification, the determination unit 121 notifies the communication unit 122 of the determination result. In a case in which the feature is determined to require notification, the determination unit 121 may transmit the determination result together with the image used for the determination to the communication unit 122. For example, in the behavior of a person, the determination unit 121 can determine that a normal motion such as walking is a feature that does not require notification, and a suspicious motion such as theft is a feature that requires notification. In the posture of a person, the determination unit 121 can determine that the feature does not require notification when the person is standing upright on a road, and determine that the feature requires notification when the person is falling down on the road. In river monitoring, the determination unit 121 can determine that the feature does not require notification in a case in which the river level of the river is less than a specified value, and determine that the feature requires notification in a case in which the river level of the river is equal to or greater than the specified value. In shelf monitoring in a convenience store, the determination unit 121 can determine that an out-of-stock state of one type of a product is a feature that does not require notification, and that an out-of-stock state of a plurality of types of the product is a feature that requires notification. The determination unit 121 may execute the determination on the basis of a rule base or may execute the determination on the basis of machine learning.

The communication unit 122 implements communication on the basis of the determination result of the feature of the image data. For example, in a case in which an abnormality is determined to exist in the feature of the image data, the communication unit 122 transmits the determination result to the network 130. In a case in which an abnormality is determined to not exist in the feature of the image data, the communication unit 122 suspends the transmission of the determination result. At this time, the communication unit 122 may transition to a sleep state until the next activation.

The control unit 123 comprehensively controls the camera 100 as a whole. At this time, the control unit 123 can cause the imaging unit 111, the determination unit 121, and the power supply control unit 124 to operate in cooperation with each other. For example, in a case in which an abnormality is determined to exist in the feature of the image data, the control unit 123 can transition to the sleep state together with the imaging unit 111 after the determination result is transmitted. Further, in a case in which an abnormality is determined to not exist in the feature of the image data, the control unit 123 can transition to the sleep state together with the imaging unit 111 without transmission of the determination result. The imaging unit 111 and the control unit 123 in the sleep state can be periodically activated and transition to the active state on the basis of a timing set in the timer 150.

The power supply control unit 124 controls the power supply circuit 140 and the timer 150. For example, the power supply control unit 124 controls the on/off of the power supply circuit 140 and controls an operation timing of the timer 150.

The network 130 provides a communication environment for the camera 100. The network 130 may include a wide area network (WAN) such as the Internet, or may include a local area network (LAN) such as Wi-Fi or Ethernet (registered trademark). Further, the network 130 may include a cellular communication network such as a mobile telephone network, or may include a short-range wireless communication network such as near field communication (NFC) or Bluetooth (registered trademark). At this time, a communication partner of the camera 100 may be a cloud, may be a local server, or may be a storage.

For example, a management center 160 and a supplier 170 are connected to the network 130. At this time, the camera 100 can communicate with the management center 160 via the network 130. The management center 160 may communicate with the supplier 170 via the network 130.

The power supply circuit 140 supplies power to the image sensor 110 and the MCU 120. Power supply systems of the image sensor 110 and the MCU 120 may be provided separately. The power supply circuit 140 may drive the camera 100 with a battery or may drive the camera 100 on the basis of power drawn from a power line.

The timer 150 sets on/off times of the power supply circuit 140, and sets a sleep time and an activation time of the power supply circuit 140. For example, the timer 150 can set the activation timing of the image sensor 110 or the MCU 120 in the sleep state with the timer 150 not being in the sleep state.

The management center 160 manages the state of a monitoring target monitored by the camera 100. The management center 160 includes a server 161 and a storage unit 162.

The server 161 determines the feature of the data acquired by the camera 100. Then, the server 161 receives, on the basis of communication implemented according to a determination result of the feature of the data, the determination result from the camera 100. For example, the server 161 can receive the determination result in a case in which an abnormality is determined to exist in the feature of the data, and can suspend reception of the determination result in a case in which an abnormality is determined to not exist in the feature of the data. The storage unit 162 stores management information necessary for response according to the determination result of the feature of the data transmitted from the camera 100.

The server 161 includes a communication unit 163 and a management unit 164. The communication unit 163 receives the determination result from the camera 100 on the basis of communication implemented according to the determination result of the feature of the data. The management unit 164 manages the determination result of the feature of the data transmitted from the camera 100. Further, the management unit 164 can manage a state of the camera 100 on the basis of communication with the camera 100. Note that the state of the camera 100 can include whether the camera 100 is in an activatable state or a non-activatable state. Note that, in the following description, the management center 160 manages products in a convenience store.

At this time, the communication unit 163 receives out-of-stock information on the products from the camera 100 on the basis of the communication implemented according to the determination result of out-of-stock states of products displayed on the shelf. The management unit 164 manages replenishment of the products on the basis of out-of-stock information on the products transmitted from the camera 100. At this time, the storage unit 162 can store quantities X1 and X2 of each product B1, B2, . . . to be delivered for each delivery destination A1. Then, when the out-of-stock information on a product is transmitted from the camera 100, the management unit 164 can access the storage unit 162, recognize the delivery destination and the quantity of the out-of-stock product, and instruct the communication unit 163 to notify the supplier 170 of the delivery destination and the quantity. The communication unit 163 notifies the supplier 170 of the delivery destination and the quantity of the out-of-stock product via the network 130 according to the instruction from the management unit 164.

The supplier 170 is provided with a server 171 and a display unit 172. The server 171 receives the instruction from the management center 160. The display unit 172 displays the out-of-stock state of the product on the basis of the instruction from the server 171. For example, the display unit 172 can display the presence or absence of the out-of-stock state of each product B1, B2,. for each delivery destination A1 . . . . Then, upon receipt of an instruction from the management center 160, the server 171 can update the out-of-stock state of the product displayed in the display unit 172. Then, the supplier 170 can identify the out-of-stock product and the delivery destination with reference to the display unit 172, and arrange delivery of the product.

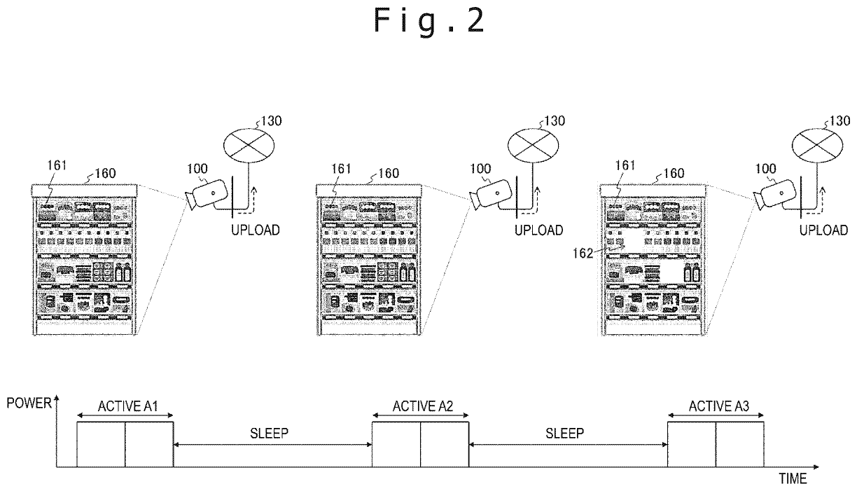

FIG. 2 is a diagram depicting an example of a communication sequence according to the first embodiment. Note that, in FIG. 2, an example of the communication sequence in normal mode is depicted. Further, in the following description of the communication sequence, shelf monitoring in a convenience store is used as an example.

In FIG. 2, a shelf 160 is installed in a convenience store. Further, in the convenience store, the camera 100 is attached at a position where the shelf 160 falls within the field of view. The camera 100 is connected to the network 130.

The camera 100 can alternately repeat the active state and the sleep state. The camera 100 can activate the active state at intervals of several tens of minutes, for example. At this time, the camera 100 in the sleep state can transition to the active state on the basis of a setting of the timer 150. When the camera 100 transitions to the active state, the imaging unit 111 images the shelf 160. Next, the AI processing unit 112 detects whether an out-of-stock item 162 exists on the shelf 160, and the determination unit 121 determines whether the out-of-stock item 162 requires notification. In normal mode, the communication unit 122 uploads a detection result of the out-of-stock item 162 on the shelf 160 to the network 130 (from active A1 to A3) without depending on the determination result of the determination unit 121. When the detection result of the out-of-stock item 162 on the shelf 160 is uploaded to the network 130, the camera 100 transitions to the sleep state.

In normal mode, even in a case in which notification of the out-of-stock item 162 on the shelf 160 is not required, the detection result of the out-of-stock item 162 on the shelf 160 is uploaded to the network 130. As a result, the active state during each activation of the camera 100 lengthens, increasing a power consumption of the camera 100 by that amount.

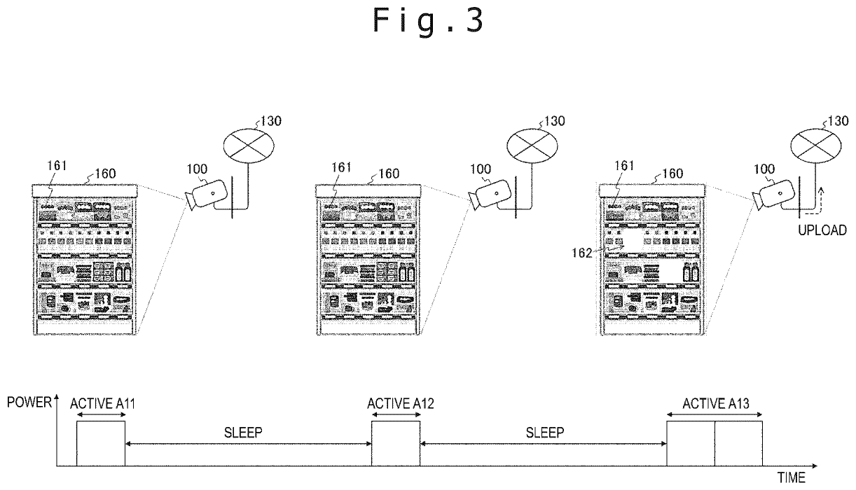

FIG. 3 is a diagram depicting another example of the communication sequence according to the first embodiment. Note that, in FIG. 3, an example of a communication sequence in power saving mode is depicted.

In FIG. 3, the camera 100 can alternately repeat the active state and the sleep state. At this time, the camera 100 in the sleep state can transition to the active state on the basis of the setting of the timer 150. In the camera 100 in the sleep state, the power supply circuit 140 and the timer 150 need only maintain the active state, making it possible to reduce the power consumption of the camera 100. When the camera 100 transitions to the active state, the imaging unit 111 images the shelf 160. Next, the AI processing unit 112 detects whether the out-of-stock item 162 exists on the shelf 160, and the determination unit 121 determines whether the out-of-stock item 162 requires notification. In a case in which notification of the out-of-stock item 162 is required, the communication unit 122 uploads the determination result to the network 130 (active A13). On the other hand, in a case in which the out-of-stock item 162 does not exist, the communication unit 122 does not upload the determination result of the out-of-stock item 162 to the network 130 (active A11 and A12). Further, in a case in which notification of the out-of-stock item 162 is not required, the communication unit 122 does not upload the determination result to the network 130. When notification of the out-of-stock item 162 is determined to be required and the determination result is uploaded to the network 130, the camera 100 transitions to the sleep state. In a case in which the out-of-stock item 162 does not exist and notification of the out-of-stock item 162 is determined to be not required, the camera 100 transitions to the sleep state without uploading the determination result to the network 130.

In power saving mode, in a case in which the out-of-stock item 162 does not exist on the shelf 160 and notification of the out-of-stock item 162 on the shelf 160 is not required, the determination result is not uploaded to the network 130. Therefore, in a case in which the out-of-stock item 162 does not exist on the shelf 160 and notification of the out-of-stock item 162 on the shelf 160 is not required, it is possible to shorten the active state of the camera 100 and reduce the power consumption of the camera 100 by that amount.

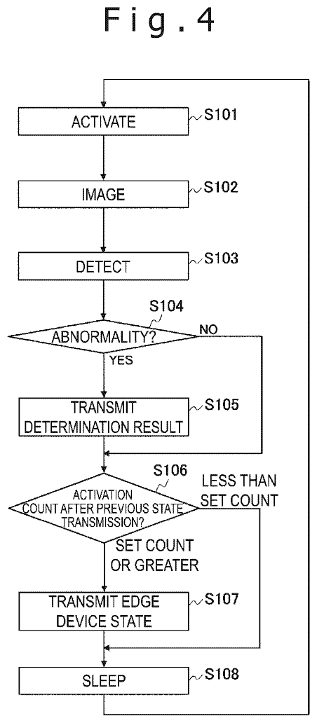

FIG. 4 is a flowchart depicting an example of a communication method according to the first embodiment.

In FIG. 4, the camera 100 in the sleep state is activated on the basis of the setting of the timer 150, and transitions to the active state (S101).

Next, when the camera 100 transitions to the active state, the imaging unit 111 images the monitoring target (S102).

Next, the AI processing unit 112 detects a feature of the image data generated by the imaging unit 111 (S103).

Next, the determination unit 121 determines whether an abnormality exists in the feature of the image data detected by the AI processing unit 112 (S104).

In a case in which an abnormality exists in the feature of the image data, the communication unit 122 transmits the determination result to the network 130 (S105). On the other hand, in a case in which an abnormality does not exist in the feature of the image data, the communication unit 122 skips the transmission of the determination result, and the processing transitions to S106.

Next, the determination unit 121 determines an activation count after the previous transmission of an edge device state (S106).

In a case in which the activation count after the previous transmission of the edge device state is a set count or greater, the communication unit 122 transmits the edge device state to the network 130 (S107). Note that the edge device state may be a remaining battery amount of the camera 100, may be a setting of the camera 100, or may be an activation count of the camera 100. The camera 100 may be set via the network 130. At this time, the power consumption can be reduced by lowering a transmission frequency. The setting of the transmission frequency may be changed from the network 130, or may be changed by utilizing image recognition by a QR code (registered trademark) or the like. On the other hand, in a case in which the activation count after the previous transmission of the edge device state is less than the set count, the transmission of the edge device state is skipped, and the processing transitions to S108.

Here, in a case in which an abnormality does not exist in the feature of the image data, the network 130 is not accessed from the camera 100. As a result, whether there is no access from the camera 100 due to an abnormality not existing in the feature of the image data, or whether there is no access from the camera 100 due to the camera 100 not operating despite an abnormality existing in the feature of the image data is not known from the network 130. In response, the operation of the camera 100 can be recognized by the communication unit 122 transmitting the edge device state to the network 130, and the network 130 side can confirm that the abnormality determination of the feature of the image data is normally implemented by the camera 100.

Next, in a case in which activation after transmission of the edge device state or after the previous transmission of the edge device state is less than the set count, the camera 100 transitions to the sleep state (S108). Note that, during sleep, a sleep mode of each device may be utilized, or power supplies other than that of the timer 150 may be turned off.

Thus, in the first embodiment described above, the communication unit 122 transmits the determination result in a case in which an abnormality is determined to exist in the feature of the image data, and suspends the communication in a case in which an abnormality is determined to not exist in the feature of the image data. Accordingly, in a case in which an abnormality does not exist in the feature of the image data, the camera 100 can reduce a communication amount, making it possible to achieve power saving.

### 2. Second Embodiment

In the first embodiment described above, the determination result is transmitted in a case in which an abnormality is determined to exist in the feature of the image data, and the communication is suspended in a case in which an abnormality is determined to not exist in the feature of the image data. In this second embodiment, in a case in which an abnormality is determined to exist in the feature of the image data, an image and the determination result are transmitted when the remaining battery amount is sufficient, and only the determination result is transmitted when the remaining battery amount is low.

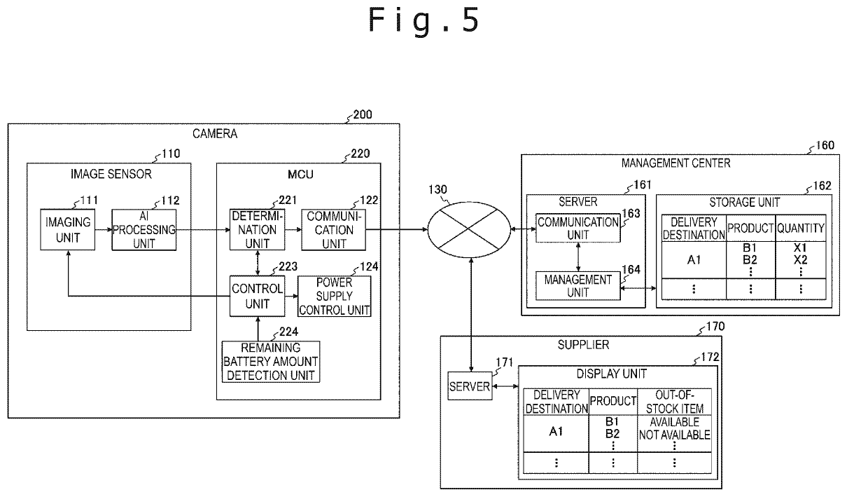

FIG. 5 is a block diagram depicting a configuration example of an imaging device according to the second embodiment.

In FIG. 5, a camera 200 includes an MCU 220 instead of the MCU 120 of the first embodiment described above. Other configurations of the camera 200 of the second embodiment are similar to the configurations of the camera 100 of the first embodiment described above.

The MCU 220 includes a determination unit 221 and a control unit 223 instead of the determination unit 121 and the control unit 123 of the first embodiment described above. Further, the MCU 220 is obtained by adding a remaining battery amount detection unit 224 to the MCU 120 of the first embodiment described above. Other configurations of the MCU 220 of the second embodiment are similar to the configurations of the MCU 120 of the first embodiment described above. Note that the remaining battery amount detection unit 224 may be added outside the MCU 120.

The remaining battery amount detection unit 224 detects a remaining amount of a battery that drives the camera 200. At this time, the battery can be mounted on the camera 200. The battery is, for example, a lithium thionyl chloride battery. Note that the battery may be mounted outside the camera 200.

The determination unit 221 determines the feature of the image data detected by the AI processing unit 112. For example, the determination unit 221 can determine whether a feature among the features of the image data detected by the AI processing unit 112 is a feature that requires notification. The determination unit 221 determines the remaining amount of the battery that is detected by the remaining battery amount detection unit 224. For example, the determination unit 221 can determine whether the remaining amount of the battery that is detected by the remaining battery amount detection unit 224 is sufficient or low. Then, in a case of determination that the feature of the image data is a feature requiring notification, the determination unit 221 can adjust the communication amount on the basis of the remaining amount of the battery. For example, when the remaining amount of the battery is sufficient, the determination unit 221 can notify the communication unit 122 of not only the determination result of the feature of the image data but also the image used for the determination. On the other hand, in a case in which the remaining amount of the battery is low, the determination unit 221 can notify the communication unit 122 of only the determination result of the feature of the image data.

The control unit 223 comprehensively controls the camera 200 as a whole. At this time, the control unit 223 can cause the imaging unit 111, the determination unit 221, and the power supply control unit 124 to operate in cooperation with each other on the basis of the remaining amount of the battery. For example, in a case in which an abnormality is determined to exist in the feature of the image data, the control unit 223 can transition to the sleep state together with the imaging unit 111 after the determination result or the image together with the determination result is transmitted in accordance with the remaining amount of the battery. Further, in a case in which an abnormality is determined to not exist in the feature of the image data, the control unit 223 can transition to the sleep state together with the imaging unit 111 without the determination result and the image being transmitted.

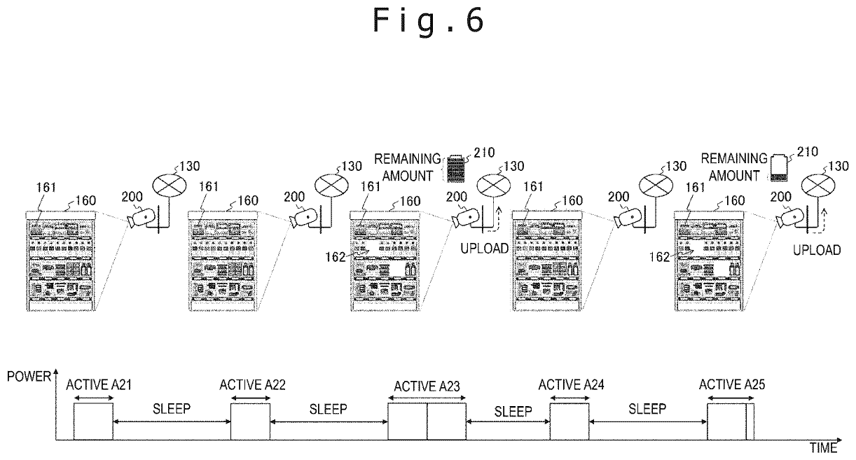

FIG. 6 is a diagram depicting an example of the communication sequence according to the second embodiment.

In FIG. 6, a battery 210 is mounted on the camera 200. The camera 200 can alternately repeat the active state and the sleep state on the basis of power supply from the battery 210. At this time, the camera 200 in the sleep state can transition to the active state on the basis of the setting of the timer 150. When the camera 200 transitions to the active state, the imaging unit 111 images the shelf 160. Next, the AI processing unit 112 detects whether an out-of-stock item 162 exists on the shelf 160, and the determination unit 221 determines whether the out-of-stock item 162 requires notification. Upon determination that the out-of-stock item 162 requires notification, the determination unit 221 determines the remaining amount of the battery 210. Then, in a case in which the remaining amount of the battery 210 is determined to be sufficient, the communication unit 122 uploads the determination result of the out-of-stock item 162 together with the image used for the determination to the network 130 (active A23). Further, in a case in which the remaining amount of the battery 210 is determined to be low, the communication unit 122 uploads only the determination result of the out-of-stock item 162 to the network 130 (active A25). On the other hand, in a case in which the out-of-stock item 162 does not exist, the communication unit 122 does not upload the determination result of the out-of-stock item 162 to the network 130 (active A21, A22, and A24). Further, in a case in which notification of the out-of-stock item 162 is not required, the communication unit 122 does not upload the determination result to the network 130. When notification of the out-of-stock item 162 is determined to be required, the camera 200 transitions to the sleep state after the determination result or the image together with the determination result is uploaded to the network 130 in accordance with the remaining amount of the battery 210. In a case in which the out-of-stock item 162 does not exist and notification of the out-of-stock item 162 is determined to be not required, the camera 200 transitions to the sleep state without uploading the determination result and the image to the network 130.

Here, only the determination result of the out-of-stock item 162 is uploaded to the network 130 when the remaining amount of the battery 210 is low, making it possible to shorten the active state of the camera 200 as compared with a case in which the image is uploaded to the network 130. This makes it possible to reduce the power consumption of the camera 200 by an amount corresponding to the shortening of the active state of the camera 200, and extend the life of the battery.

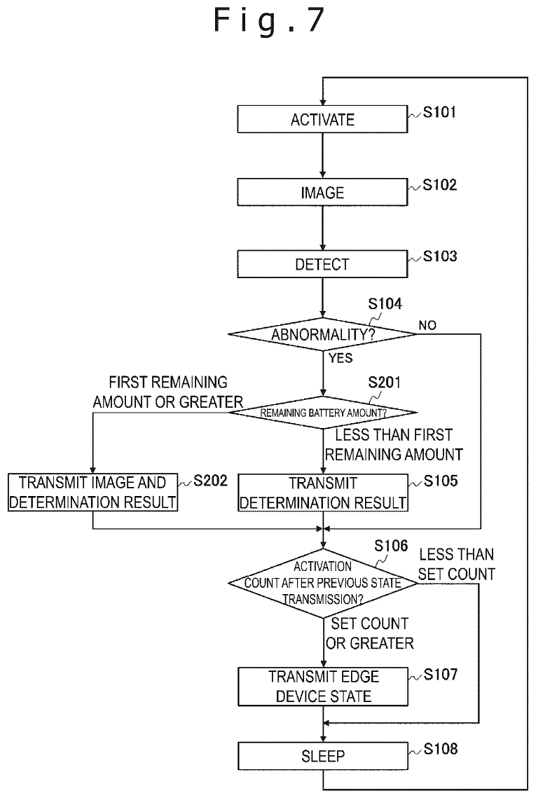

FIG. 7 is a flowchart depicting an example of the communication method according to the second embodiment.

In FIG. 7, this flow is obtained by adding the processing of S201 and S202 to the flow of the first embodiment described above. Other processing of the flow of the second embodiment is similar to the processing of the flow of the first embodiment described above.

In the flow of the second embodiment, upon determination that an abnormality exists in the feature of the image data detected by the AI processing unit 112 (S104), the determination unit 121 determines the remaining amount of the battery mounted on the camera 200 (S201).

In a case in which the remaining amount of the battery is the first remaining amount or greater, the communication unit 122 transmits the determination result together with the image used for the determination to the network 130 (S202), and the processing transitions to S106. On the other hand, in a case in which the remaining amount of the battery is less than the first remaining amount, the communication unit 122 transmits only the determination result to the network 130 (S105), and the processing transitions to S106. Note that the first remaining amount can be set to a value at which the remaining amount of the battery is sufficient. Further, a type of data transmitted in accordance with the remaining amount of the battery may be changed in accordance with the use case. For example, the image may be compressed or the file format may be changed in accordance with the remaining amount of the battery.

Thus, in the second embodiment described above, in a case in which an abnormality is determined to exist in the feature of the image data, the communication unit 122 transmits the image and the determination result when the remaining battery amount is sufficient, and transmits only the determination result when the remaining battery amount is low. Accordingly, the communication unit 122 can adjust the communication amount in accordance with the remaining battery amount, and the life of the battery can be extended while enabling notification of the abnormality in the feature of the image data.

### 3. Third Embodiment

In the second embodiment described above, in a case in which an abnormality is determined to exist in the feature of the image data, the image and the determination result are transmitted when the remaining battery amount is sufficient, and only the determination result is transmitted when the remaining battery amount is low. In this third embodiment, in a case in which an abnormality is determined to exist in the feature of the image data, a plurality of the determination results are collectively transmitted when the remaining battery amount is substantially depleted.

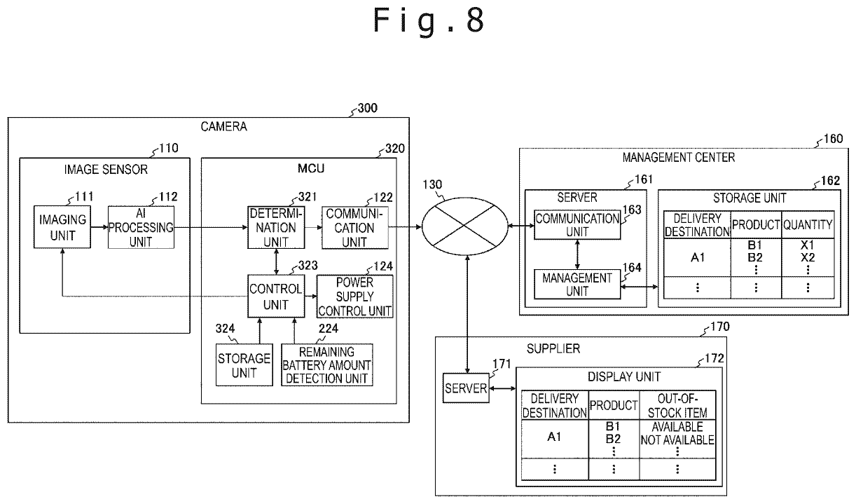

FIG. 8 is a block diagram depicting a configuration example of an imaging device according to a third embodiment.

In FIG. 8, a camera 300 includes an MCU 320 instead of the MCU 220 of the second embodiment described above. Other configurations of the camera 300 of the third embodiment are similar to the configurations of the camera 200 of the second embodiment described above.

The MCU 320 includes a determination unit 321 and a control unit 323 instead of the determination unit 221 and the control unit 223 of the second embodiment described above. Further, the MCU 320 is obtained by adding a storage unit 234 to the MCU 220 of the second embodiment described above. Other configurations of the MCU 320 of the third embodiment are similar to the configurations of the MCU 220 of the second embodiment described above. Note that the storage unit 234 may be added outside the MCU 220.

The determination unit 321 determines the feature of the image data detected by the AI processing unit 112. For example, the determination unit 321 can determine whether a feature among the features of the image data detected by the AI processing unit 112 is a feature that requires notification. Further, the determination unit 321 determines the remaining amount of the battery that is detected by the remaining battery amount detection unit 224. For example, the determination unit 321 can determine whether the remaining amount of the battery that is detected by the remaining battery amount detection unit 224 is sufficient, low, or substantially depleted. Then, in a case of determination that the feature of the image data is a feature requiring notification, the determination unit 321 can adjust the communication amount on the basis of the remaining amount of the battery. For example, when the remaining amount of the battery is sufficient, the determination unit 321 can notify the communication unit 122 of not only the determination result of the feature of the image data but also the image used for the determination. In a case in which the remaining amount of the battery is low, the determination unit 321 can notify the communication unit 122 of only the determination result of the feature of the image data. On the other hand, in a case in which the remaining amount of the battery is substantially depleted, the determination unit 321 can collectively notify the communication unit 122 of a plurality of only the determination results of the feature of the image data.

The control unit 323 comprehensively controls the camera 300 as a whole. At this time, the control unit 323 can cause the imaging unit 111, the determination unit 321, the storage unit 324, and the power supply control unit 124 to operate in cooperation with each other on the basis of the remaining amount of the battery and an accumulation count of the determination results of the feature of the image data. The control unit 323 can store data in the storage unit 324 on the basis of the determination results of the determination unit 321. For example, in a case in which an abnormality is determined to exist in the feature of the image data, the control unit 323 can store the determination result together with the image used for the determination in the storage unit 324. Then, the control unit 323 can transition to the sleep state together with the imaging unit 111 after the determination result or the image together with the determination result is transmitted in accordance with the remaining amount of the battery. Further, in a case in which an abnormality is determined to exist in the feature of the image data, the control unit 323 can transition to the sleep state together with the imaging unit 111 after a plurality of only the determination results are collectively transmitted in accordance with the remaining amount of the battery and the accumulation count of the determination results. Further, in a case in which an abnormality is determined to not exist in the feature of the image data, the control unit 323 can transition to the sleep state together with the imaging unit 111 without the determination result and the image being transmitted.

The storage unit 324 stores the determination result of the feature of the image data. The storage unit 324 may be a volatile memory such as a dynamic random access memory (DRAM) or may be a nonvolatile memory such as a flash memory. In a case in which a volatile memory is used as the storage unit 324, a power supply of the storage unit 324 can be maintained even when the camera 300 transitions to the sleep state.

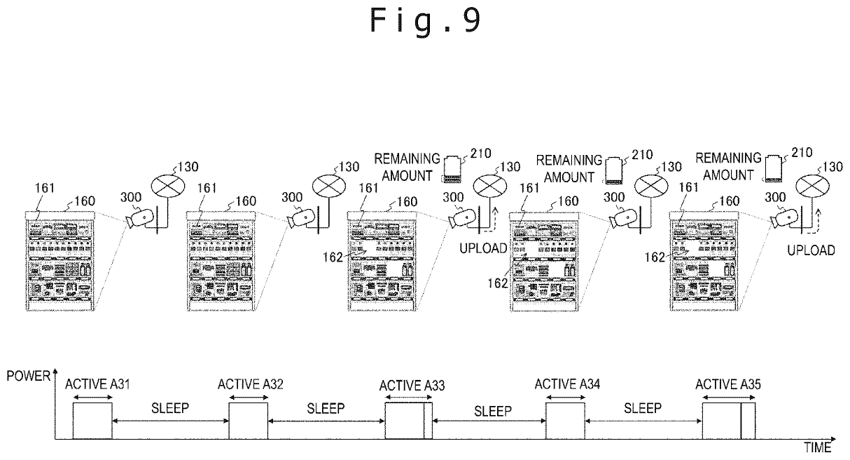

FIG. 9 is a diagram depicting an example of the communication sequence according to the third embodiment.

In FIG. 9, the camera 300 can alternately repeat the active state and the sleep state on the basis of the power supply from the battery 210. At this time, the camera 300 in the sleep state can transition to the active state on the basis of the setting of the timer 150. When the camera 300 transitions to the active state, the imaging unit 111 images the shelf 160. Next, the AI processing unit 112 detects whether the out-of-stock item 162 exists on the shelf 160, and the determination unit 321 determines whether the out-of-stock item 162 requires notification. Upon determination that the out-of-stock item 162 requires notification, the determination unit 321 determines the remaining amount of the battery 210. Then, in a case in which the remaining amount of the battery 210 is determined to be sufficient, the communication unit 122 uploads the determination result of the out-of-stock item 162 together with the image used for the determination to the network 130. Further, in a case in which the remaining amount of the battery 210 is determined to be low, the communication unit 122 uploads only the determination result of the out-of-stock item 162 to the network 130 (active A33). Furthermore, in a case in which the remaining amount of the battery 210 is determined to be substantially depleted, the communication unit 122 collectively uploads a plurality of only the determination results of the out-of-stock item 162 to the network 130 (active A35). On the other hand, in a case in which the out-of-stock item 162 does not exist, the communication unit 122 does not upload the determination result of the out-of-stock item 162 to the network 130 (active A31 and A32). Further, in a case in which notification of the out-of-stock item 162 is not required, the communication unit 122 does not upload the determination result to the network 130. Further, in a case in which the remaining amount of the battery 210 is determined to be substantially depleted and a plurality of the determination results of the out-of-stock item 162 are not accumulated, the communication unit 122 does not upload the determination result to the network 130 (active A34). When notification of the out-of-stock item 162 is determined to be required, the camera 300 transitions to the sleep state when the determination result or the image together with the determination result is uploaded to the network 130 in accordance with the remaining amount of the battery and the accumulation count of the determination results of the out-of-stock item 162. In a case in which the out-of-stock item 162 does not exist and notification of the out-of-stock item 162 is determined to be not required, the camera 300 transitions to the sleep state without uploading the determination result and the image to Here, when the remaining amount of the battery is substantially depleted, a plurality of only the determination results of the out-of-stock item 162 are collectively uploaded to the network 130. This makes it possible to shorten the active state of the camera 300 as compared with a case in which only the determination results of the out-of-stock item 162 are individually uploaded to the network 130 each time. Thus, the power consumption of the camera 300 can be reduced by an amount corresponding to the shortening of the active state of the camera 300, and the life of the battery can be extended.

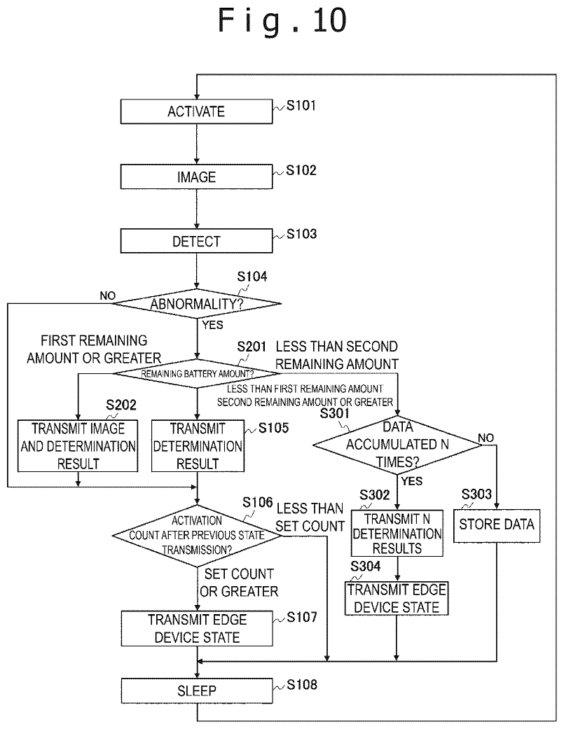

FIG. 10 is a flowchart depicting an example of the communication method according to the third embodiment.

In FIG. 10, this flow is obtained by adding the processing from S301 to S304 to the flow of the second embodiment described above. Other processing of the flow of the third embodiment is similar to the processing of the flow of the second embodiment described above.

In the flow of the third embodiment, in a case in which the remaining amount of the battery is the first remaining amount or greater, the communication unit 122 transmits the determination result together with the image used for the determination to the network 130 (S202), and the processing transitions to S106. In a case in which the remaining amount of the battery is less than the first remaining amount and equal to or greater than the second remaining amount, the communication unit 122 transmits only the determination result to the network 130 (S105), and the processing transitions to S106. Note that the second remaining amount can be set to a value at which the remaining amount of the battery is substantially depleted.

On the other hand, in a case in which the remaining amount of the battery is less than the second remaining amount, the determination unit 321 determines whether the determination result of the abnormality of the feature of the image data has been accumulated N times (N being an integer of 2 or greater; S301). In a case in which the determination result of the abnormality of the feature of the image data has been accumulated N times, the communication unit 122 collectively transmits only the determination results of N times to the network 130 (S302). Then, the communication unit 122 transmits the edge device state to the network 130 (S304) and subsequently, the processing transitions to S108. On the other hand, in a case in which the determination result of the abnormality of the feature of the image data has not been accumulated N times, the control unit 323 stores the current determination result of the abnormality of the feature of the image data in the storage unit 324 (S303), and the processing transitions to S108. Note that a type of data transmitted in accordance with the remaining amount of the battery may be changed in accordance with the use case.

Thus, in the third embodiment described above, in a case in which an abnormality is determined to exist in the feature of the image data, the communication unit 122 collectively transmits a plurality of the determination results when the remaining battery amount is substantially depleted. Accordingly, the communication unit 122 can adjust the communication count in accordance with the remaining battery amount, and extend the life of the battery while enabling notification of the abnormality in the feature of the image data.

Note that, in a case in which the remaining battery amount is substantially depleted, a plurality of the determination results may be stored locally. Further, when the remaining battery amount increases on the basis of a combination with energy harvesting or a solar cell, data transmission may be implemented.

### 4. Fourth Embodiment

In the second embodiment described above, in a case in which an abnormality is determined to exist in the feature of the image data, the image and the determination result are transmitted when the remaining battery amount is sufficient, and only the determination result is transmitted when the remaining battery amount is low. In this fourth embodiment, the communication interval is extended when the remaining battery amount is low.

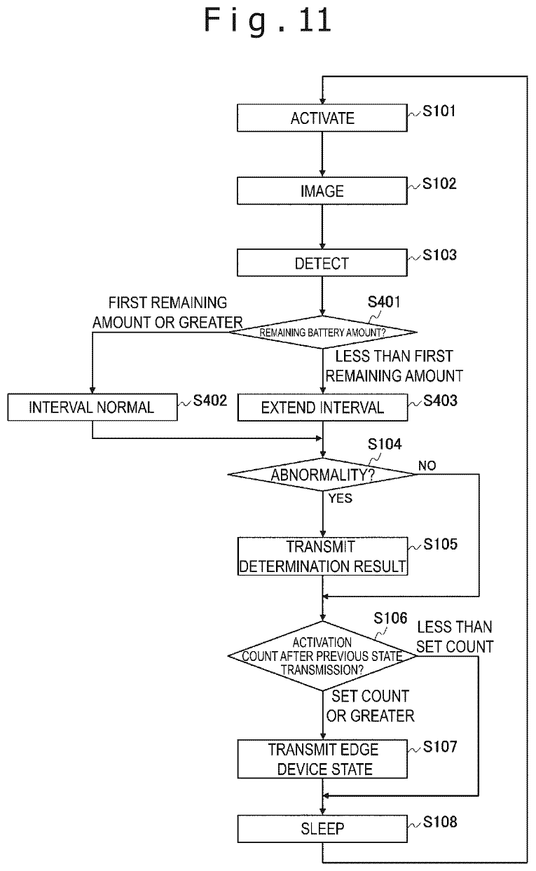

FIG. 11 is a flowchart depicting an example of the communication method according to the fourth embodiment.

In FIG. 11, this flow is obtained by adding the processing from S401 to S403 to the flow of the first embodiment described above. Other processing of the flow of the fourth embodiment is similar to the processing of the flow of the first embodiment described above.

In the flow of the fourth embodiment, when the AI processing unit 112 detects the feature of the image data (S103), the determination unit 221 determines the remaining amount of the battery mounted on the camera 200 (S401).

In a case in which the remaining amount of the battery is the first remaining amount or greater, the control unit 223 sets the communication interval to normal (S402), and the processing transitions to S104. On the other hand, in a case in which the remaining amount of the battery is less than the first remaining amount, the control unit 223 extends the communication interval (S403), and the processing transitions to S104. For example, the camera 200 can activate the active state at intervals of several tens of minutes in a case in which the remaining amount of the battery is the first remaining amount or greater, and activate the active state at intervals of several hours in a case in which the remaining amount of the battery is less than the first remaining amount. The communication interval can be stored in a storage unit mounted on the camera 200. Note that the communication interval may be set to three or more levels in accordance with the use case.

In this way, in the fourth embodiment described above, the communication unit 122 extends the communication interval when the remaining battery amount is low. Accordingly, the communication unit 122 can adjust the communication frequency in accordance with the remaining battery amount, and extend the life of the battery while enabling notification of an abnormality in the feature of the image data.

### 5. Fifth Embodiment

In the fourth embodiment described above, the communication interval is extended when the remaining battery amount is low. In this fifth embodiment, when the remaining battery amount is low, the battery is switched to a spare battery.

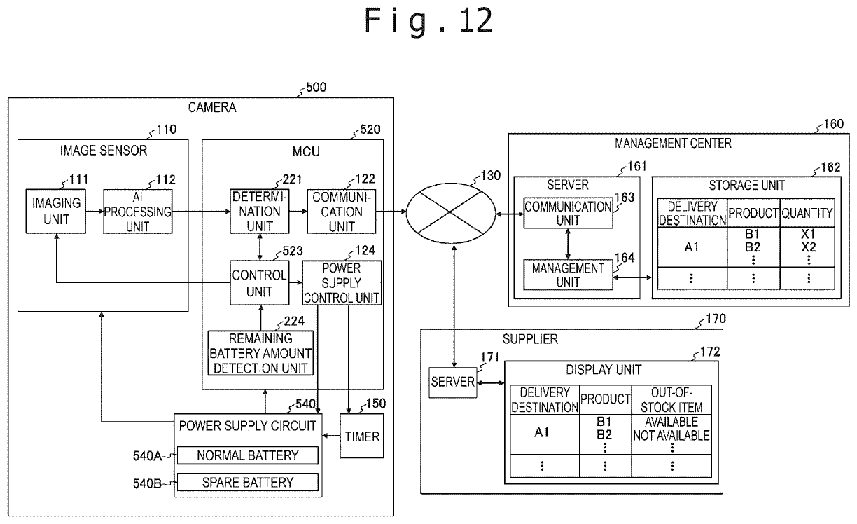

FIG. 12 is a block diagram depicting a configuration example of an imaging device according to a fifth embodiment.

In FIG. 12, a camera 500 includes an MCU 520 and a power supply circuit 540 instead of the MCU 220 and the power supply circuit 140 of the second embodiment described above. Other configurations of the camera 500 of the fifth embodiment are similar to the configurations of the camera 200 of the second embodiment described above.

The MCU 520 includes a control unit 523 instead of the control unit 223 of the second embodiment described above. Other configurations of the MCU 520 of the fifth embodiment are similar to the configurations of the MCU 220 of the second embodiment described above.

The control unit 523 comprehensively controls the camera 500 as a whole. At this time, the control unit 523 can cause the imaging unit 111, the determination unit 221, and the power supply control unit 124 to operate in cooperation with each other on the basis of the remaining amount of the battery. For example, the control unit 523 can instruct the power supply control unit 124 to switch between a normal battery 540A and a spare battery 540B in accordance with the remaining battery amount. Further, in a case in which an abnormality is determined to exist in the feature of the image data, the control unit 523 can transition to the sleep state together with the imaging unit 111 after the determination result is transmitted. Further, in a case in which an abnormality is determined to not exist in the feature of the image data, the control unit 523 can transition to the sleep state together with the imaging unit 111 without the determination result being transmitted.

The power supply circuit 540 includes the normal battery 540A and the spare battery 540B. The normal battery 540A and the spare battery 540B supply power to the image sensor 110 and the MCU 520. The normal battery 540A and the spare battery 540B may be the same type or may be different types. The normal battery 540A and the spare battery 540B may have the same capacity or may have different capacities. For example, the normal battery 540A may be a lithium thionyl chloride battery, and the spare battery 540B may be a LiMnO₂ battery having a low internal resistance. The normal battery 540A may be a LiMnO₂ battery, and the spare battery 540B may be a large-capacity battery. Note that the normal battery 540A and the spare battery 540B may be added outside the camera 500.

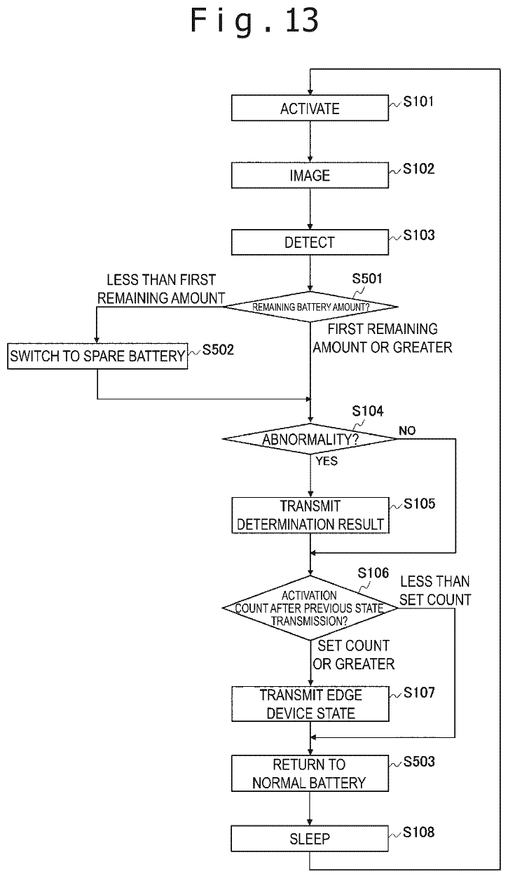

FIG. 13 is a flowchart depicting an example of the communication method according to the fifth embodiment.

In FIG. 13, this flow is obtained by adding the processing from S501 to S503 to the flow of the first embodiment described above. Other processing of the flow of the fifth embodiment is similar to the processing of the flow of the first embodiment described above.

In the flow of the fifth embodiment, when the AI processing unit 112 detects the feature of the image data (S103), the determination unit 221 determines the remaining amount of the normal battery 540A (S501).

In a case in which the remaining amount of the normal battery 540A is the first remaining amount or greater, the control unit 523 causes the processing to transition to the S104. On the other hand, in a case in which the remaining amount of the normal battery 540A is less than the first remaining amount, the control unit 523 switches the power supply of the camera 500 from the normal battery 540A to the spare battery 540B (S502), and causes the processing to transition to S104.

Further, after the communication unit 122 transmits the edge device state (S107), the control unit 523 returns the power supply of the camera 500 from the spare battery 540B to the normal battery 540A (S503).

In this way, in the fifth embodiment described above, the control unit 523 switches to the spare battery 540B when the remaining amount of the normal battery 540A is low. Accordingly, even when the remaining amount of the normal battery 540A is low, the camera 500 can issue a notification of the abnormality of the feature of the image data on the basis of the battery power.

### 6. Sixth Embodiment

In the first embodiment described above, the determination result is transmitted in a case in which an abnormality is determined to exist in the feature of the image data, and the communication is suspended in a case in which an abnormality is determined to not exist in the feature of the image data. In this sixth embodiment, the communication interval is shortened when a change in the image data is large, and the communication interval is extended when a change in the image data is small.

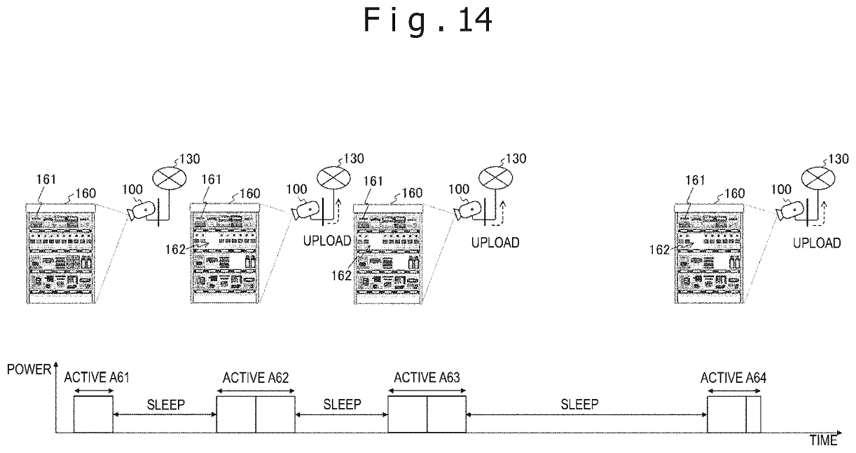

FIG. 14 is a diagram depicting an example of the communication sequence according to the sixth embodiment.

In FIG. 14, the camera 100 can alternately repeat the active state and the sleep state. At this time, the camera 100 in the sleep state can transition to the active state on the basis of the setting of the timer 150. When the camera 100 transitions to the active state, the imaging unit 111 images the shelf 160. Next, the AI processing unit 112 detects whether the out-of-stock item 162 exists on the shelf 160. Next, the determination unit 121 determines a change amount between the image data processed last time by the AI processing unit 112 and the image data processed this time by the AI processing unit 112. Then, the determination unit 121 shortens the communication interval when the change amount between the image data is large, and extends the communication interval when the change amount between the image data is small. Next, when the out-of-stock item 162 exists on the shelf 160, the determination unit 121 determines whether notification of the out-of-stock item 162 on the shelf 160 is required. In a case in which notification of the out-of-stock item 162 is required, the communication unit 122 uploads the determination result to the network 130 (active A62, A63, and A64). On the other hand, when the out-of-stock item 162 does not exist, the communication unit 122 does not upload the determination result of the out-of-stock item 162 to the network 130 (active A61). Further, in a case in which notification of the out-of-stock item 162 is not required, the communication unit 122 does not upload the determination result to the network 130. When notification of the out-of-stock item 162 is determined to be required and the determination result is uploaded to the network 130, the camera 100 transitions to the sleep state. In a case in which the out-of-stock item 162 does not exist and notification of the out-of-stock item 162 is determined to be not required, the camera 100 transitions to the sleep state without uploading the determination result to the network 130. At this time, the communication interval is changed on the basis of an increase or decrease in the change amount between the image data, and the sleep period is increased or decreased. To increase or decrease the sleep period, the control unit 123 can instruct the power supply control unit 124 to change the setting of the timer 150 on the basis of the determination result of the determination unit 121.

By changing the communication interval on the basis of the increase or decrease in the change amount between the image data, it is possible to reduce the communication amount when the change in the state of the out-of-stock item 162 is small. This makes it possible to shorten the active state of the camera 100 while reducing a redundancy in the notification of the out-of-stock item 162 and reduce the power consumption of the camera 100 by that amount.

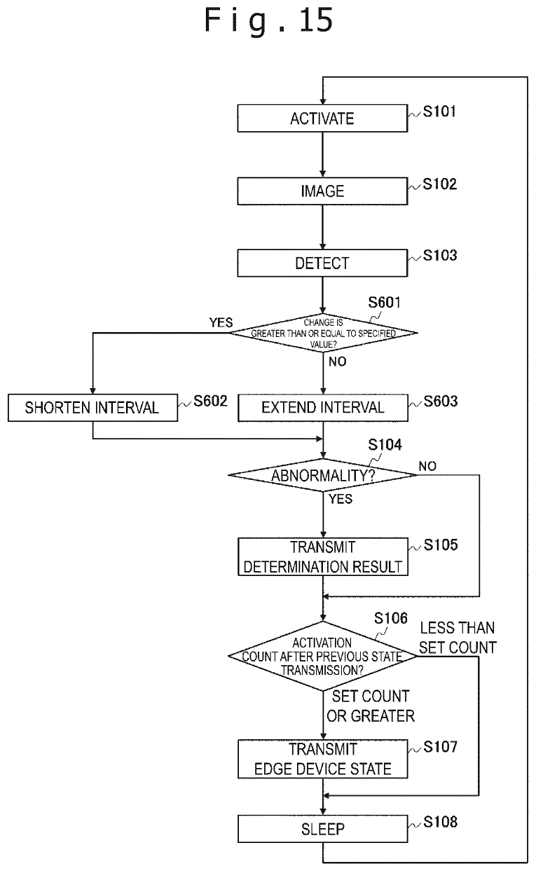

FIG. 15 is a flowchart depicting an example of the communication method according to the sixth embodiment.

In FIG. 15, this flow is obtained by adding the processing from S601 to S603 to the flow of the first embodiment described above. Other processing of the flow of the sixth embodiment is similar to the processing of the flow of the first embodiment described above.

In the flow of the sixth embodiment, when the AI processing unit 112 detects the feature of the image data (S103), the determination unit 121 determines whether a change in the image data is a specified value or greater (S601).

In a case in which the change in the image data is the specified value or greater, the determination unit 121 shortens the communication interval (S602), and the processing transitions to S104. On the other hand, in a case in which the change in the image data is less than the specified value, the determination unit 121 extends the communication interval (S603), and the processing transitions to S104. Note that the communication interval may be changed in three or more stages in accordance with the use case. Further, the communication interval may be set in accordance with a temperature, a season, a time zone, or the like. For example, in a refrigerator shelf on which a beverage is placed, the communication interval may be shortened during the daytime in summer, and the communication interval may be shortened during the nighttime in winter.

In this way, in the sixth embodiment described above, the determination unit 121 shortens the communication interval when the change in the image data is large, and extends the communication interval when the change in the image data is small. Accordingly,

the communication unit 122 can adjust the communication frequency in accordance with the change amount in the image data, and extend the life of the battery while enabling notification of an abnormality in the feature of the image data. For example, in a convenience store, a supermarket, or the like, a change in a quantity of a product 161 on the shelf 160 is large during peak hours, but the change in the quantity of the product 161 on the shelf 160 is small during off-peak hours. During the off-peak hours in which the change in the quantity of the product 161 on the shelf 160 is small, the communication interval is extended, making it possible to extend the life of the battery while suppressing a failure of notification of the out-of-stock item 162.

### 7. Seventh Embodiment

In the sixth embodiment described above, the communication interval is shortened when the change in the image data is large, and the communication interval is extended when the change in the image data is small. In this seventh embodiment, in a case in which an abnormality is determined to exist in the feature of the image data, the determination result is transmitted when a change exists from the previous communication time, and the determination result is not transmitted when a change does not exist from the previous communication time.

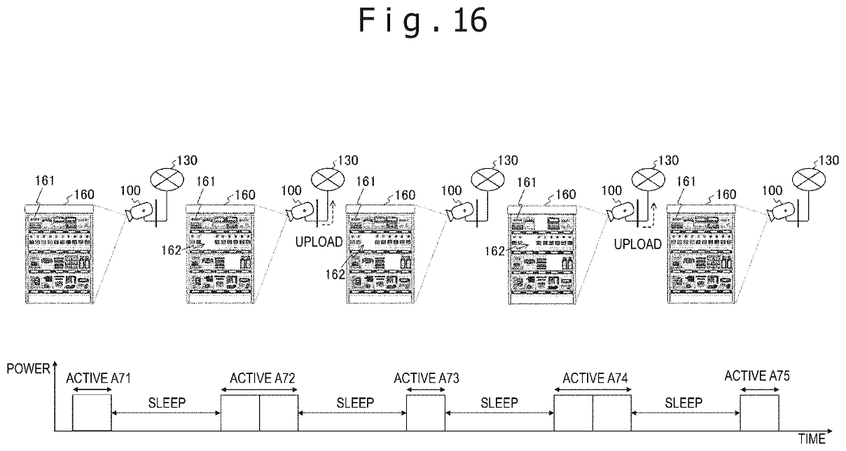

FIG. 16 is a diagram depicting an example of the communication sequence according to the seventh embodiment.

In FIG. 16, the camera 100 can alternately repeat the active state and the sleep state. At this time, the camera 100 in the sleep state can transition to the active state on the basis of the setting of the timer 150. When the camera 100 transitions to the active state, the imaging unit 111 images the shelf 160. Next, the AI processing unit 112 detects whether the out-of-stock item 162 exists on the shelf 160, and the determination unit 121 determines whether the out-of-stock item 162 requires notification. In a case in which notification of the out-of-stock item 162 is required, the determination unit 121 determines whether the state of the out-of-stock item 162 matches the state of the out-of-stock item 162 at the time of the previous transmission. In a case in which the current state of the out-of-stock item 162 matches the state of out-of-stock item 162 at the time of the previous transmission, the communication unit 122 does not upload the current determination result to the network 130 (active A73). On the other hand, in a case in which the current state of the out-of-stock item 162 is determined to not match the state of the out-of-stock item 162 at the time of the previous transmission, the communication unit 122 uploads the current determination result to the network 130 (active A72 and A74). On the other hand, when the out-of-stock item 162 does not exist,

the communication unit 122 does not upload the determination result of the out-of-stock item 162 to the network 130 (active A71 and A75). Further, in a case in which notification of the out-of-stock item 162 is not required, the communication unit 122 does not upload the determination result to the network 130. When notification of the out-of-stock item 162 is determined to be required and the determination result is uploaded to the network 130, the camera 100 transitions to the sleep state. In a case in which the out-of-stock item 162 does not exist and notification of the out-of-stock item 162 is determined to be not required, the camera 100 transitions to the sleep state without uploading the determination result to the network 130. Further, in a case in which the current state of the out-of-stock item 162 matches the state of the out-of-stock item 162 at the time of the previous transmission, the camera 100 transitions to the sleep state without uploading the current determination result to the network 130.

By determining whether transmission is performed on the basis of a change in the state of the out-of-stock item 162, it is possible to not implement communication when a change does not exist in the state of the out-of-stock item 162. This makes it possible to shorten the active state of the camera 100 without a failure of notification of the out-of-stock item 162, and reduce the power consumption of the camera 100 accordingly.

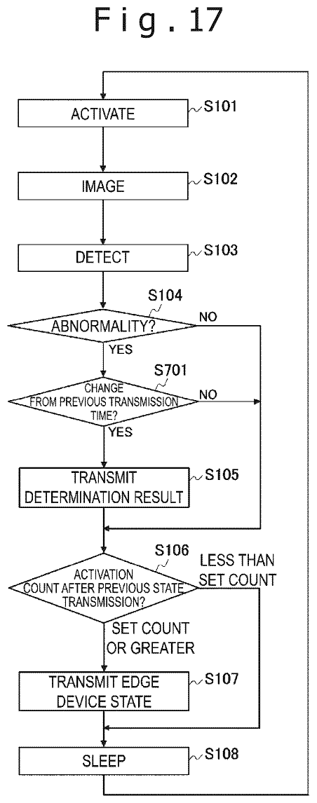

FIG. 17 is a flowchart depicting an example of the communication method according to the seventh embodiment.

In FIG. 17, this flow is obtained by adding the processing of S701 to the flow of the first embodiment described above. Other processing of the flow of the seventh embodiment is similar to the processing of the flow of the first embodiment described above.

In the flow of the seventh embodiment, upon determination of whether an abnormality exists in the feature of the image data detected by the AI processing unit 112 (S104), the determination unit 121 determines whether the abnormality in the feature of the image data changed from the previous transmission (S701).

In a case in which the abnormality of the feature of the image data changed from the previous transmission, the determination unit 121 causes the processing to transition to S105. On the other hand, in a case in which the abnormality of the feature of the image data has not changed from the previous transmission, the determination unit 121 causes the processing to transition to S106.

In this way, in this seventh embodiment described above, in a case in which an abnormality is determined to exist in the feature

of the image data, the communication unit 122 transmits the determination result in a case in which a change exists from the previous communication time, and does not transmit the determination result in a case in which a change does not exist from the previous communication time. Accordingly, even in a case in which an abnormality exists in the feature of the image data, the communication unit 122 cannot transmit the abnormality in the feature of the image data when a change does not exist in the abnormality in the feature of the image data. This makes it possible to extend the life of the battery without reducing an information amount of the notification of the abnormality in the feature of the image data.

### 8. Eighth Embodiment

In the first embodiment described above, the determination unit 121 that determines the feature of the image data is provided in the MCU 120. In this eighth embodiment, the determination unit that determines the feature of the image data is provided in an image sensor.

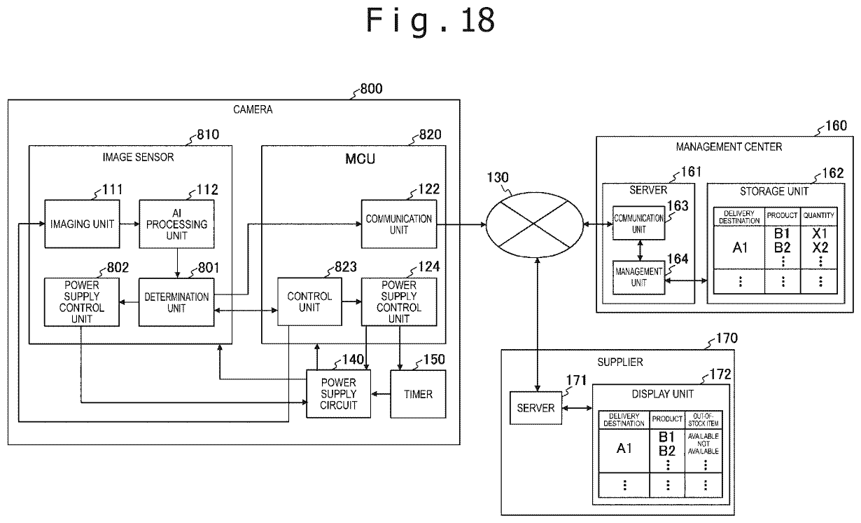

FIG. 18 is a block diagram depicting a configuration example of an imaging device according to the eighth embodiment.

In FIG. 18, a camera 800 includes an image sensor 810 and an MCU 820 instead of the image sensor 110 and the MCU 120 of the first embodiment described above. Other configurations of the camera 800 of the eighth embodiment are similar to the configurations of the camera 100 of the first embodiment described above.

The image sensor 810 is obtained by adding a determination unit 801 and a power supply control unit 802 to the image sensor 110 of the first embodiment described above. Other configurations of the image sensor 810 of the eighth embodiment are similar to the configurations of the image sensor 110 of the first embodiment described above.

The MCU 820 includes a control unit 823 instead of the control unit 123 of the first embodiment described above. Further, the MCU 820 is obtained by removing the determination unit 121 from the MCU 120 of the first embodiment described above. Other configurations of the MCU 820 of the eighth embodiment are similar to the configurations of the MCU 120 of the first embodiment described above.

The determination unit 801 is connected to the AI processing unit 112. At this time, the AI processing unit 112 can output the feature of the image data detected by the AI processing unit 112 to the determination unit 801 without an interface interposed therebetween. The determination unit 801 determines the feature of the image data detected by the AI processing unit 112. For example, the determination unit 801 can determine whether a feature among the features of the image data detected by the AI processing unit 112 is a feature that requires notification. Then, upon determination that the feature requires notification, the determination unit 801 transmits the determination result to the MCU 820 and notifies the communication unit 122 of the determination result.

The power supply control unit 802 controls the power supply circuit 140. In this case, the power supply control unit 802 may control a power supply system of the image sensor 810 separately from a power supply system of the MCU 820.

The control unit 823 comprehensively controls the camera 800 as a whole. At this time, the control unit 823 can cause the imaging unit 111, the determination unit 801, and the power supply control unit 124 to operate in cooperation with each other. For example, in a case in which the image sensor 810 notifies the control unit 823 of a determination result that an abnormality exists in the feature of the image data, the control unit 823 can transition to the sleep state together with the imaging unit 111 after the determination result is transmitted from the communication unit 122. Further, in a case in which the image sensor 810 notifies the control unit 823 of a determination result that an abnormality does not exist in the feature of the image data, the control unit 823 can transition to the sleep state together with the imaging unit 111 without the determination result being transmitted from the communication unit 122. The imaging unit 111 and the control unit 823 in the sleep state can be periodically activated and transition to the active state on the basis of a timing set in the timer 150.

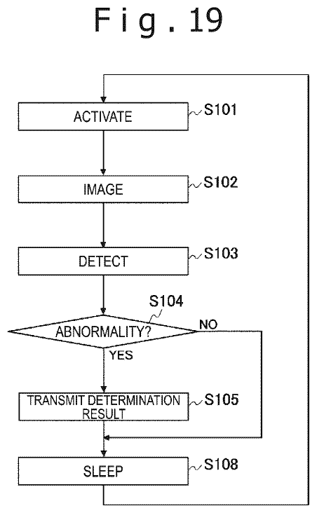

FIG. 19 is a flowchart depicting an example of the communication method according to the eighth embodiment.

In FIG. 19, this flow is obtained by removing the processing of S106 and S107 from the flow of the first embodiment described above. Other processing of the flow of the eighth embodiment is similar to the processing of the flow of the first embodiment described above.

In a case in which an abnormality exists in the feature of the image data, the communication unit 122 transmits the determination result of the feature of the image data to the network 130 (S105), and the processing transitions to S108. On the other hand, in a case in which an abnormality does not exist in the feature of the image data, the communication unit 122 skips the transmission of the determination result, and the processing transitions to the S108.

Here, the determination of the feature of the image data is implemented in the image sensor 810. Therefore, in a case in which an abnormality does not exist in the feature of the image data, it is possible to eliminate the need to transfer the data from the image sensor 810 to the MCU 820, and reduce the power consumption by that amount.

Thus, in the eighth embodiment described above, the determination unit 801 that determines the feature of the image data is provided in the image sensor 810. This makes it possible to reduce data transfer time from the AI processing unit 112 to the determination unit 801, and reduce a time lag of the data from when the image data is generated by the imaging unit 111 to when the determination result is generated by the determination unit 801.

### 9. Ninth Embodiment

In the first embodiment described above, the imaging unit 111 and the AI processing unit 112 are provided in the image sensor 110. In this ninth embodiment, a semiconductor chip on which a pixel array section of the imaging unit 111 is provided and a semiconductor chip on which a peripheral circuit of the imaging unit 111 and the AI processing unit 112 are provided are layered.

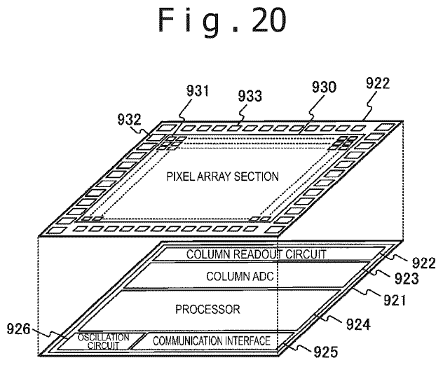

FIG. 20 is a perspective view depicting a layering example of a solid-state imaging device according to the ninth embodiment. In this drawing, the solid-state imaging device includes semiconductor chips 921 and 922. The semiconductor chip 922 is layered on the semiconductor chip 921.

A pixel array section 930 is formed on the semiconductor chip 922. In the pixel array section 930, pixels 931 are disposed in a matrix in the row direction and the column direction. A pad electrode 932 and a via electrode 933 are formed around the pixel array section 930. The via electrode 933 can penetrate the semiconductor chip 922 and electrically connect the semiconductor chips 921 and 922 to each other. The pixel array section 930 can be provided in the imaging unit 111.

The semiconductor chip 921 includes a column readout circuit 922, a column ADC 923, a processor 924, a communication interface 925, and an oscillation circuit 926. The column readout circuit 922 can form a source follower with each pixel 931 during readout of the pixel signal from each pixel 931. The column ADC 923 performs analog-to-digital (AD) conversion on the pixel signal from each pixel 931 for each column. The processor 924 processes the pixel signal that has been AD-converted in the column ADC 923. The processor 924 can be provided with the AI processing unit 112. The communication interface 925 transmits data output from the processor 924 to the MCU 120. At this time, the communication interface 925 can transmit the data output from the AI processing unit 112 to the MCU 120. The oscillation circuit 926 supplies a clock to the processor 924 and the communication interface 925.

Thus, in the ninth embodiment described above, the semiconductor chip 922 on which the pixel array section 930 of the imaging unit 111 is provided and the semiconductor chip 921 on which the peripheral circuit of the imaging unit 111 and the AI processing unit 112 are provided are layered. This makes it possible to increase a sensitivity of the image sensor 110 while suppressing an increase in a mounting area of the semiconductor chip 922 provided with the pixel array section 930.

Note that, in the embodiments described above, an imaging device that implements communication of the determination result of the feature of the image data has been described as an example. The present invention is not necessarily limited to an imaging device, and may be a communication device that implements communication of the determination result of the feature of data. This data is not necessarily limited to the image data and, for example, may be event data, may be temperature data, may be vibration data, may be flow rate data, or may be pressure data.

### 10. Application Example of Mobile Body

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

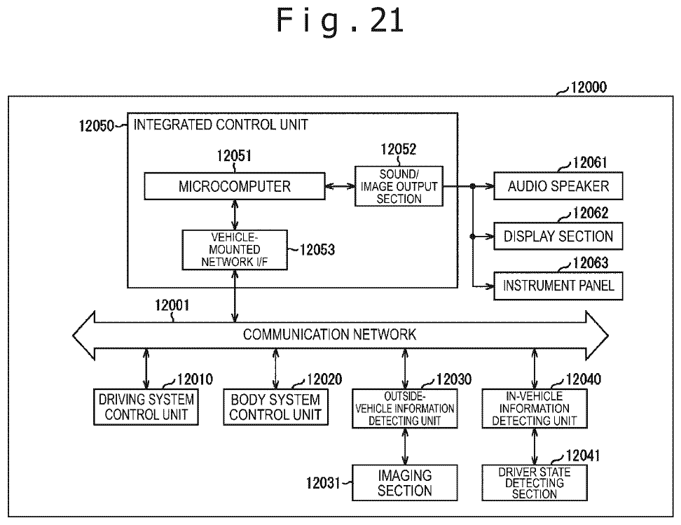

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver.

The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

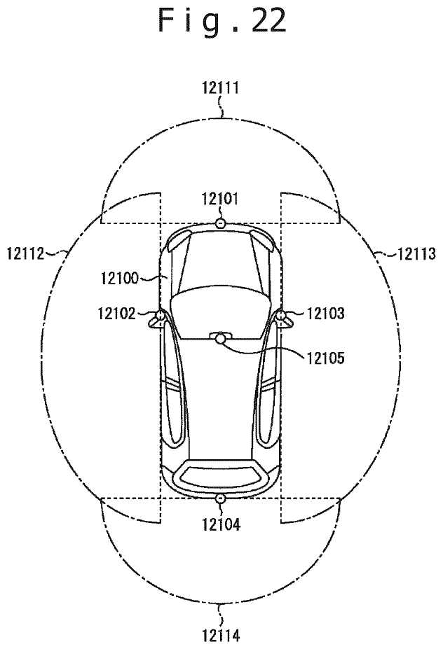

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like among the configurations described above. Specifically, for example, the cameras of the first to ninth embodiments described above can be applied to the imaging section 12031 and the like. By applying the technology according to the present disclosure to the vehicle control system 12000, it is possible to reduce the power consumption of the imaging section 12031 while providing the imaging section 12031 with a monitoring function.

Note that the above-described embodiments illustrate examples for embodying the present technology, and the matters in the embodiments have corresponding relations with the matters specifying the invention in the scope of the claims. Similarly, the matters specifying the invention in the scope of the claims have corresponding relations with the matters in the embodiments of the present technology to which the same names are given. However, the present technology is not limited to the embodiments, and can be embodied by applying various modifications to the embodiments without departing from the gist thereof. Further, the effects described in the present specification are merely examples and are not limited, and other effects may be provided.

Note that the present technology can also adopt configurations such as the following.
(1) A communication device including:
a determination unit configured to determine a feature of data; and
a communication unit configured to communicate, on the basis of a determination result of the feature of the data, the determination result.
(2) The communication device according to (1), further including:
a feature detection unit configured to detect the feature of the data.
(3) The communication device according to (2), further including:
a sensor configured to generate the data.
(4) The communication device according to (3),
wherein the sensor includes the feature detection unit.
(5) The communication device according to (3) or (4),
wherein the sensor includes the determination unit.
(6) The communication device according to any one of (3) to (5), including
a controller configured to control the sensor.
(7) The communication device according to (6),
wherein the controller includes the determination unit and the communication unit.
(8) The communication device according to any one of (1) to (7),
wherein the communication unit transmits the determination result when an abnormality is determined to exist in the feature of the data and suspends the communication when an abnormality is determined to not exist in the feature of the data.
(9) The communication device according to (8), further including:
a remaining amount detection unit configured to detect a remaining amount of a battery configured to drive the determination unit and the communication unit.
(10) The communication device according to (9),
wherein the communication unit transmits the data and the determination result when the remaining amount of the battery is a first remaining amount or greater and transmits the determination result without transmitting the data when the remaining amount of the battery is less than the first remaining amount.
(11) The communication device according to (10),
wherein the communication unit transmits the data and the determination result when the remaining amount of the battery is equal to or less than a second remaining amount that is less than the first remaining amount and collectively transmits a plurality of the determination results when the remaining amount of the battery is less than the first remaining amount.
(12) The communication device according to any one of (9) to (11),
wherein the communication unit extends a communication interval on the basis of the remaining amount of the battery.
(13) The communication device according to any one of (9) to (12), further including:
a power supply control unit configured to switch to battery power by a spare battery on the basis of the remaining amount of the battery.
(14) The communication device according to any one of (9) to (13),
wherein the communication unit extends a communication interval on the basis of a change amount in the data.
(15) The communication device according to any one of (1) to (14),
wherein the communication unit transmits the determination result when the feature of the data changes and suspends the communication when the feature of the data does not change.
(16) The communication device according to any one of (1) to (15),
wherein the communication unit transmits an operation state on the basis of activation.
(17) An imaging device including:
an imaging unit configured to perform imaging;
a detection unit configured to detect a feature of image data generated by the imaging unit;
a determination unit configured to determine the feature of the image data; and
a communication unit configured to, on the basis of a determination result of the feature of the image data, communicate the determination result.
(18) The communication device according to (17),
wherein the communication unit transmits the determination result when an abnormality is determined to exist in the feature of the image data and suspends transmission of the determination result when an abnormality is determined to not exist in the feature of the image data.
(19) A communication method including:
determining a feature of data by a server; and
receiving, on the basis of communication implemented according to a determination result of the feature of the data, the determination result by the server.
(20) The communication method according to (19),
wherein the server receives the determination result when an abnormality is determined to exist in the feature of the data, and
the server suspends reception of the determination result when an abnormality is determined to not exist in the feature of the data.

### REFERENCE SIGNS LIST

100 Camera
110 Image sensor
120 MCU
130 Network
140 Power supply circuit
150 Timer
111 Imaging unit
112 AI processing unit
121 Determination unit
122 Communication unit
123 Control unit
124 Power supply control unit

1. A communication device comprising:
a determination unit configured to determine a feature of data; and
a communication unit configured to communicate, on the basis of a determination result of the feature of the data, the determination result.

2. The communication device according to claim 1, further comprising:
a feature detection unit configured to detect the feature of the data.

3. The communication device according to claim 2, further comprising:
a sensor configured to generate the data.

4. The communication device according to claim 3,
wherein the sensor includes the feature detection unit.

5. The communication device according to claim 3,
wherein the sensor includes the determination unit.

6. The communication device according to claim 3, comprising a controller configured to control the sensor.

7. The communication device according to claim 6,
wherein the controller includes the determination unit and the communication unit.

8. The communication device according to claim 1,
wherein the communication unit transmits the determination result when an abnormality is determined to exist in the feature of the data and suspends the communication when an abnormality is determined to not exist in the feature of the data.

9. The communication device according to claim 8, further comprising:
a remaining amount detection unit configured to detect a remaining amount of a battery configured to drive the determination unit and the communication unit.

10. The communication device according to claim 9,
wherein the communication unit transmits the data and the determination result when the remaining amount of the battery is a first remaining amount or greater and transmits the determination result without transmitting the data when the remaining amount of the battery is less than the first remaining amount.

11. The communication device according to claim 10,
wherein the communication unit collectively transmits a plurality of the determination results when the remaining amount is less than a second remaining amount that is less than the first remaining amount.

12. The communication device according to claim 9,
wherein the communication unit extends a communication interval on the basis of the remaining amount of the battery.

13. The communication device according to claim 9, further comprising:
a power supply control unit configured to switch to battery power by a spare battery on the basis of the remaining amount of the battery.

14. The communication device according to claim 9,
wherein the communication unit extends a communication interval on the basis of a change amount in the data.

15. The communication device according to claim 1,
wherein the communication unit transmits the determination result when the feature of the data changes and suspends the communication when the feature of the data does not change.

16. The communication device according to claim 1,
wherein the communication unit transmits an operation state on the basis of activation.

17. An imaging device comprising:
an imaging unit configured to perform imaging;
a detection unit configured to detect a feature of image data generated by the imaging unit;
a determination unit configured to determine the feature of the image data; and
a communication unit configured to communicate, on the basis of a determination result of the feature of the image data, the determination result.

18. The communication device according to claim 17,
wherein the communication unit transmits the determination result when an abnormality is determined to exist in the feature of the image data and suspends transmission of the determination result when an abnormality is determined to not exist in the feature of the image data.

19. A communication method comprising:
determining a feature of data by a server; and
receiving, on the basis of communication implemented according to a determination result of the feature of the data, the determination result by the server.

20. The communication method according to claim 19,
wherein the server receives the determination result when an abnormality is determined to exist in the feature of the data, and
the server suspends reception of the determination result when an abnormality is determined to not exist in the feature of the data.
